(19) United States
(12) Patent Application Publication
(10) Pub. No.: US 2008/0140396 A1
(43) Pub. Date: Jun. 12, 2008

(54) MODEL-BASED SIGNAL ENHANCEMENT SYSTEM

(76) Inventors: Dominik Grosse-Schulte, Taunusstein Hahn (DE); Mohamed Krini, Ulm (DE); Gerhard Uwe Schmidt, Ulm (DE)

Correspondence Address: BRINKS HOFER GILSON & LIONE, P.O. BOX 10395, CHICAGO, IL, 60610, US

(21) Appl. No.: 11/928,251

(22) Filed: Oct. 30, 2007

(30) Foreign Application Priority Data
Oct. 31, 2006 (EP) 06022704.8

(51) Int. Cl. G10L 21/02

(52) U.S. Cl. 704/227

(57) ABSTRACT

A signal processing system enhances a speech input signal. A signal reconstruction circuit receives the speech input signal and extracts a spectral envelope. The signal reconstruction circuit generates an excitation signal based on the input signal, and generates a reconstructed speech signal based on the extracted spectral envelope and an excitation signal. A combining circuit combines the noise reduced signal and the reconstructed speech signal. Signal reconstruction and signal combinations may be based on a signal-to-noise ratio of the speech signal or another input.

### BACKGROUND OF THE INVENTION

1. Priority Claim

This application claims the benefit of priority from European Patent Application No. 06 022704.8, filed Oct. 31, 2006, which is incorporated by reference.

2. Technical Field

This disclosure relates to a signal enhancement system. In particular, this disclosure relates to a model-based signal enhancement system using codebooks for signal reconstruction.

3. Related Art

Speech signals in two-way communication systems may be degraded by background noise. Background noise may affect the quality of speech signals in wireless devices operated in vehicles. Background noise may also affect the recognition accuracy of speech recognition systems in vehicles.

Single channel noise reduction systems may use spectral subtraction to reduce background noise. However, spectral subtraction may be limited to reducing stationary noise variations and positive signal-to-noise distances, and may result in distorted signals. Multi-channel systems using a microphone array may reduce background noise. However, such systems may be expensive and may not sufficiently reduce background noise. Single channel and multi-channel systems may not adequately reduce background noise when the signal-to-noise ratio is below about 10 dB.

### SUMMARY

A signal processing system enhances a speech input signal. A noise reduction circuit generates a noise reduced signal. A signal reconstruction circuit receives the speech input signal and extracts a spectral envelope from the speech input signal. A signal reconstruction circuit generates an excitation signal based on the speech input signal, and generates a reconstructed speech signal based on the extracted spectral envelope and the excitation signal. The noise reduced signal and the reconstructed speech signal are combined to generate an enhanced speech output. The input-to-noise ratio or a signal-to-noise ratio of the speech input signal may control signal reconstruction and signal combining.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a model-based signal enhancement system.

FIG. 2 is a signal reconstruction process.

FIG. 3 is a model-based signal enhancement system.

FIG. 4 is a noise power estimation process.

FIG. 5 is a classification process.

FIG. 6 is a signal reconstruction circuit.

FIG. 7 is a weighting process.

FIG. 8 is a signal enhancement process.

FIG. 9 is a spreading function.

### DETAILED DESCRIPTION OF THE PREFERRED EMBODIMENTS

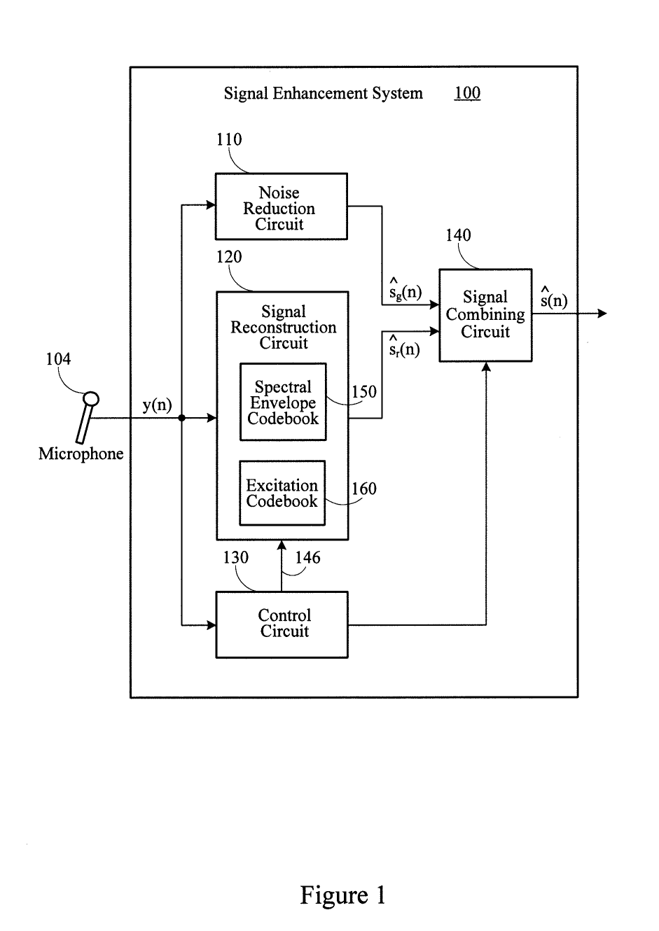

FIG. 1 is a signal enhancement system 100. The signal enhancement system 100 may be a model-based system. One or more microphones 104 may capture speech and may generate a speech input signal “y(n).” The signal enhancement system 100 may include a noise reduction circuit or noise reduction filter 110, a signal reconstruction circuit 120, a control circuit 130, and a signal combining circuit 140. The noise reduction circuit 110, the signal reconstruction circuit 120, and the control circuit 130 may each receive the speech input signal “y(n).” The noise reduction circuit 110 may generate a noise reduced signal ŝ_{g}(n). The signal reconstruction circuit 120 may generate a reconstructed speech signal ŝᵣ(n). The signal combining circuit 140 may combine the noise the reduced signal ŝ_{g}(n) and the reconstructed speech signal ŝᵣ(n) based on operating parameters 146 provided by the control circuit 130, and may generate an enhanced speech output signal ŝ (n). The argument “n” may be the discrete time index.

The signal enhancement system 100 may be used with wireless communication systems to provide an enhanced communication signal. The signal enhancement system 100 may provide an enhanced signal to a voice recognition system, which may improve the recognition accuracy of the voice recognition system.

The noise reduced signal ŝ_{g}(n) may represent a noise reduced speech input signal “y(n).” Portions of the speech input signal “y(n)” having a low input-to-noise ratio may not be sufficiently enhanced by some noise reduction processes. For input signals having a signal-to-noise ratio of about 10 dB or less, some noise reduction circuits may deteriorate a noisy input signal. For such signals having a low input-to-noise ratio or signal-to-noise ratio, the reconstructed speech signal ŝᵣ(n) may be used to obtain an enhanced speech output signal with reduced noise and enhanced intelligibility.

The signal reconstruction circuit 120 may reconstruct a speech signal based on feature analysis of the speech input signal y(n). The signal reconstruction circuit 120 may estimate a spectral envelope of an unperturbed speech signal based on an extracted spectral envelope of the speech input signal y(n). The signal reconstruction circuit 120 may use a spectral envelope codebook 150 containing a plurality of prototype spectral envelopes based on prior training, and may estimate an unperturbed excitation signal using an excitation codebook 160. The reconstructed speech signal ŝᵣ(n) may be generated based on the short-time spectral envelope and the estimated excitation signal.

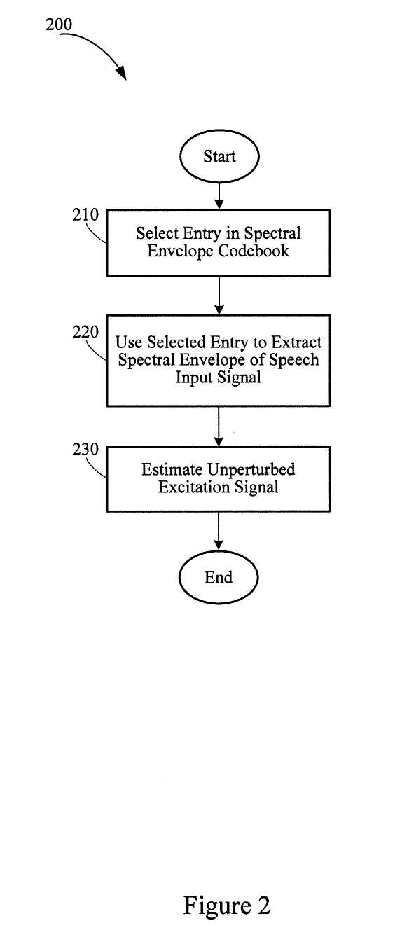

FIG. 2 is a signal reconstruction process 200. An entry in the spectral envelope codebook 150 may be selected (Act 210). The spectral envelope codebook 150 may contain a plurality of prototype spectral envelopes based on prior training. Based on the select entry, a spectral envelope of the speech input signal may be extracted (Act 220). Using the extracted spectral envelope of the speech input signal, an unperturbed excitation signal may be estimated (Act 230).

The control circuit 130 of FIG. 1 may estimate a short-time power density spectrum of the noise in the speech input signal y(n), and may detect a short-time spectrogram of the speech input signal y(n). The short-time power density spectrum of the noise signal may be a noise power density spectrum. The control circuit 130 may classify the input signal y(n) as a voice or unvoiced signal. The control circuit 130 may provide the operating parameters 146 to the signal reconstruction circuit 120 to control its operation.

The signal combining circuit 140 may combine the noise reduced signal ŝ_{g}(n) and the reconstructed speech signal ŝᵣ(n) based on the signal-to-noise ratio or the input-to-noise ratio. The signal-to-noise ratio and the input-to-noise ratio may be based on an estimated noise level of the speech input signal y(n). The signal combining circuit 140 may combine the noise reduced signal ŝ_{g}(n) and the reconstructed speech signal ŝ^{r}(n) in programmed or predetermined proportions using weighting values. The weighting values may depend on the noise level. Signal portions that may be perturbed by noise may be replaced by the corresponding portions of the reconstructed speech signal ŝᵣ(n).

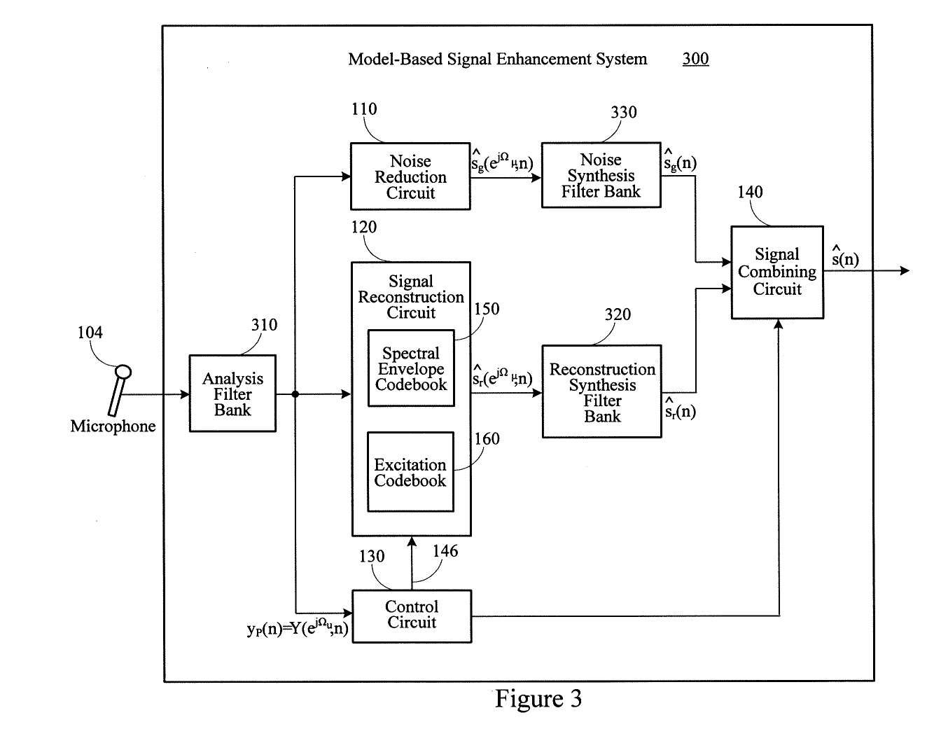

FIG. 3 is a model-based signal enhancement system 300. An analysis filter or filter bank 310 may process the input signal y(n) and may perform a Fourier transform or additional filtering. The analysis filter bank 310 may generate a processed input signal y_{P}(n), and may provide the processed input signal to the noise reduction circuit 110, the signal reconstruction circuit 120, and/or the control circuit 130. The control circuit 130 may estimate the signal-to-noise ratio or the input-to-noise ratio of the processed input signal y_{P}(n).

The control circuit 130 may classify the processed input signal y_{P}(n) as a voice or unvoiced signal. The control circuit 130 may determine the input-to-noise ratio or the signal-to-noise ratio by calculating a ratio of the short-time spectrogram of the processed speech input signal y_{P}(n) and the short-time power density spectrum of noise present in the processed speech input signal y_{P}(n). The short-time spectrogram may be the squared magnitude of the short-time spectrum. Calculation of the short-time spectrogram and the short-time power density spectrum may be described in an article entitled “Acoustic Echo and Noise Control,” by E. Hänsler, G. Schmidt (Wiley, Hoboken, N.J., USA, 2004), which is incorporated by reference.

The control circuit 130 may deactivate the signal reconstruction circuit 120 if the input-to-noise ratio or the signal-to-noise ratio of the processed speech input signal y_{P}(n) exceeds a programmed or predetermined threshold for the processed speech input signal. The signal reconstruction circuit 120 may be deactivated if the perturbation of the processed input speech signal y_{P}(n) is sufficiently low so that the noise reduction circuit 110 may reduce the noise level without reconstruction.

The control circuit 130 may use the input-to-noise ratio or the signal-to-noise ratio in processing. The signal-to-noise ratio may be calculated based on the input-to-noise ratio, where the signal-to-noise ratio (Ω_{μ},n)=max{0, input-to-noise ratio (Ω_{μ},n)−1}. The parameter “n” may denote the discrete time index, and Ω_{μ} may denote discrete frequency nodes provided by the analysis filter bank 310. The parameter Ω_{μ} may denote nodes of a discrete Fourier transform for transforming the speech input signal to the frequency domain. The control circuit 130 may perform processing in the frequency domain or in the time domain.

The control circuit 130 may estimate the input-to-noise ratio or the signal-to-noise ratio by determining three quantities: 1) a short-time power density spectrum of noise in the speech input signal y(n); 2) a short-time spectrogram of the speech input signal y(n); and 3) an estimate of the noise power density spectrum for a discrete time index n.

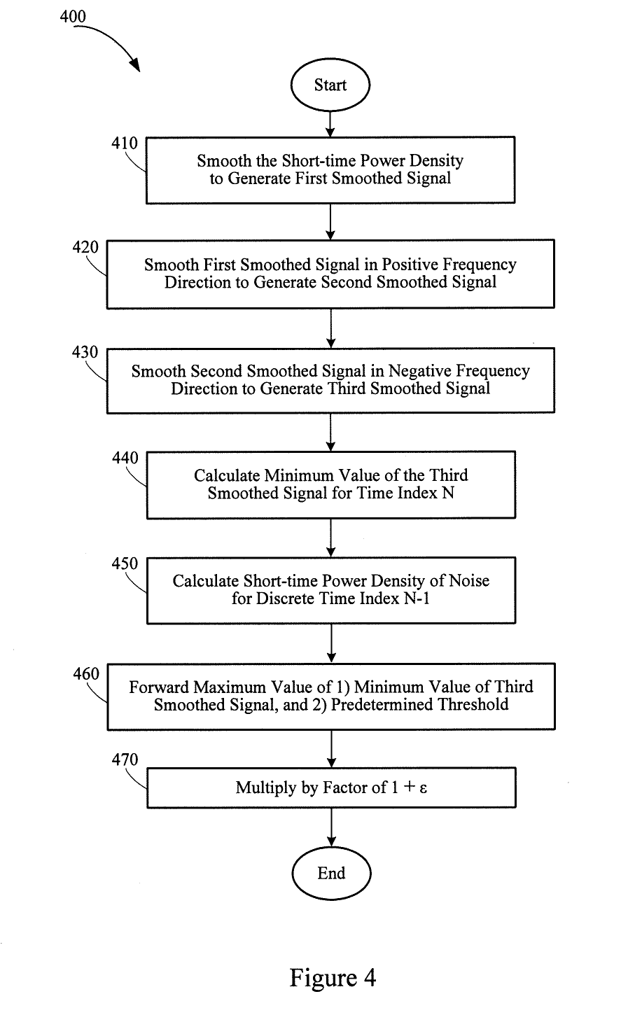

FIG. 4 is a process (Act 400) that estimates the noise power density spectrum for a discrete time index “n”. The short-time power density spectrum of the speech input signal “y(n)” may be smoothed in time to generate a first smoothed short-time power density spectrum (Act 410). Next, the first smoothed short-time power density spectrum may be smoothed in a positive frequency direction to generate a second smoothed short-time power density spectrum (Act 420). The second smoothed short-time power density spectrum may then be smoothed in a negative frequency direction to generate a third smoothed short-time power density spectrum (Act 430).

A minimum value of the third smoothed short-time power density spectrum for the discrete time index “n” may be calculated (Act 440), and the short-time power density spectrum of noise for a discrete time index “n−1” may be estimated (Act 450). The estimated short-time power density spectrum of noise for the discrete time index “n−1” may be based on the estimated short-time power density spectrum of noise for a discrete time index “n−2”.

To prevent or minimize divergence or freezing of the processing during estimation of the noise power density spectrum, the noise power density spectrum may be estimated as a maximum of the following two quantities (Act 460):

1) the minimum value of the third smoothed short-time power density spectrum for the discrete time index n; and

2) a predetermined threshold value.

The minimum value of the third smoothed short-time power density spectrum may be multiplied by a factor of “1+ε”, where ε is a positive real number much less than 1 (Act 470). A fast reaction of the estimation relative to temporal variations may be realized by adjustment of the value for ε.

The analysis filter bank 310 of FIG. 3 may process the speech input signal “y(n)” and generate a plurality of sub-band signals or short-time spectra Y(e^{jΩ}^{_{μ}}, n), with frequency nodes Ω_{μ}(μ=0, 1, . . . , M−1). The noise reduction circuit 110, the signal reconstruction circuit 120, and/or the control circuit 130 may receive the sub-band signals Y(e^{jΩ}^{_{μ}}, n), and may operate in the frequency domain. A reconstruction synthesis filter bank 320 may synthesize the sub-band signals and generate the reconstructed speech signal ŝᵣ(n). A noise synthesis filter bank 330 may synthesize the sub-band signals and generate the noise reduced signal ŝ_{g}(n). Processing may be performed in the time domain or the frequency domain.

The quality of the enhanced speech output signal ŝ (n) may depend on the accuracy of the noise estimate. The speech input signal “y(n)” may contain speech pauses. The noise estimate may be improved by measuring the noise during the speech pauses. The short-time spectrogram of the speech input signal “y(n)” may be represented as |Y(e^{jΩ}^{_{μ}}, n)|², and may be determined during the speech pauses. The short-time spectrogram of the speech input signal “y(n)” may be used to estimate the short-time power density spectrum of the background noise.

The short-time power density spectrum of the noise present in the speech input signal “y(n)” may be estimated by smoothing of the short-time power density spectrum of the speech input signal “y(n)” in both time and frequency, including a minimum search. Smoothing in time may be performed as an Infinite Impulse Response (IIR) process according to Equation 1:

S̅_{yy}(Ω_{μ},n)=λ_{T} S̅_{yy}(Ω_{μ},n−1)+(1−λ_{T}) |Y(e^{jΩ}^{_{μ}},n)|² (Eqn. 1)

where 0≦λ_{T}<1. Decreasing the value of λ_{T} may increase the speed of the estimation.

The Infinite Impulse Response (IIR) smoothing in frequency may be performed based on Equation 2:

$${\overline{S}}_{yy}^{′} ( {Ω}_{μ} , n ) = \{ \begin{matrix}{\overline{S}}_{yy} ( {Ω}_{μ} , n ) , & if μ = 0 \\ {λ}_{F} {\overline{S}}_{yy}^{′} ( {Ω}_{μ - 1} , n ) + ( 1 - {λ}_{F} ) {\overline{S}}_{yy} ( {Ω}_{μ} , n ) , & if μ ∈ \{ 1 , … , M - 1 \}\end{matrix} \qquad ( Eqn . 2 )$$

followed by processing based on Equation 3:

$${\overline{S}}_{yy}^{″} ( {Ω}_{μ} , n ) = \{ \begin{matrix}{\overline{S}}_{yy}^{′} ( {Ω}_{μ} , n ) , & if μ = M - 1 \\ {λ}_{F} {\overline{S}}_{yy}^{″} ( {Ω}_{μ + 1} , n ) + ( 1 - {λ}_{F} ) {\overline{S}}_{yy}^{′} ( {Ω}_{μ} , n ) , & if μ ∈ \{ 0 , … , M - 2 \}\end{matrix} \qquad ( Eqn . 3 )$$

where 0≦λ_{F}<1. Smoothing in frequency may reduce or avoid the occurrence of “outliers,” which may cause perceptible artifacts in the output signal.

The estimated short-time power density spectrum of the noise may be determined based on Equation 4:

Ŝₙₙ(Ω_{μ},n)=max {S_{nn,min},min{Ŝₙₙ(Ω_{μ},n−1), S̅″_{yy}(Ω_{μ},n)}(1+ε)} (Eqn. 4)

where 0<ε<<1. The value of the limiting threshold S_{nn,min} may ensure that the estimated short-time power density spectrum does not approach zero. The value of the parameter ε may be set greater than zero to ensure a reaction to a temporal increase of the noise power density.

Based on the short-time power density spectrum of the noise Ŝₙₙ(Ω_{μ},n), the control circuit 130 may estimate the input-to-noise ratio based on Equation 5:

(Ω_{μ},n)=|Y(e^{jΩ}^{_{μ}}, n)|²/Ŝₙₙ(Ω_{μ},n) (Eqn. 5)

The input-to-noise ratio may be used in subsequent signal processing.

The signal combining circuit 140 may combine the reconstructed speech signal ŝᵣ(n) and the noise reduced signal ŝ_{g}(n) based on the input-to-noise ratio. Alternatively, the noise estimate may be based on the signal-to-noise ratio according to Equation 6:

(Ω_{μ},n)=max {0, input-to-noise ratio (Ω_{μ},n)−1} (Eqn. 6)

The control circuit 130 may classify the speech input signal y(n) as voiced or unvoiced. An audio portion of the speech input signal y(n) may be classified as voiced if a classification parameter t_{c}(n) (0≦t_{c}(n)≦1) is large. Conversely, an audio portion of the speech input signal “y(n)” may be classified as unvoiced if the classification parameter t_{c}(n) (0≦t_{c}(n)≦1) is small. The classification parameter t_{c}(n) may be determined from a non-linear mapping of the quantity r_{input-to-noise ratio}(n) based on Equation 7:

r_{input-to-noise ratio}(n)=(input-to-noise ratio_{high}(n)/(input-to-noise ratio_{low}(n)+Δ_{input-to-noise ratio}) (Eqn. 7)

where the constant, Δ_{input-to-noise ratio}, may prevent division by zero, where the

$$input \text{-} to \text{-} noise {ratio}_{high} ( n ) = \frac{1}{{μ}_{3} - {μ}_{2} + 1} {\sum }_{μ = {μ}_{2}}^{{μ}_{3}} INR ( {Ω}_{μ} , n ) ,$$

and where the

$$input \text{-} to \text{-} noise {ratio}_{low} ( n ) = \frac{1}{{μ}_{1} - {μ}_{0} + 1} {\sum }_{μ = {μ}_{0}}^{{μ}_{1}} INR ( {Ω}_{μ} , n ) .$$

The normalized frequencies Ω_{μ0}, Ω_{μ1}Ω_{μ2} and Ω_{μ3} may be selected to correspond to the audio frequencies of 300 Hz, 1050 Hz, 3800 Hz and 5200 Hz, respectively. A binary classification may be obtained based on Equation 8:

t_{c}(n)=f(r_{input-to-noise ratio}(n))=1 (Eqn. 8)

where the r_{input-to-noise ratio}(n) may be set below a threshold value. Unvoiced portions of the speech input signal y(n) may exhibit a dominant power density in the high frequency range, while voiced portions may exhibit a dominant power density in the low frequency range.

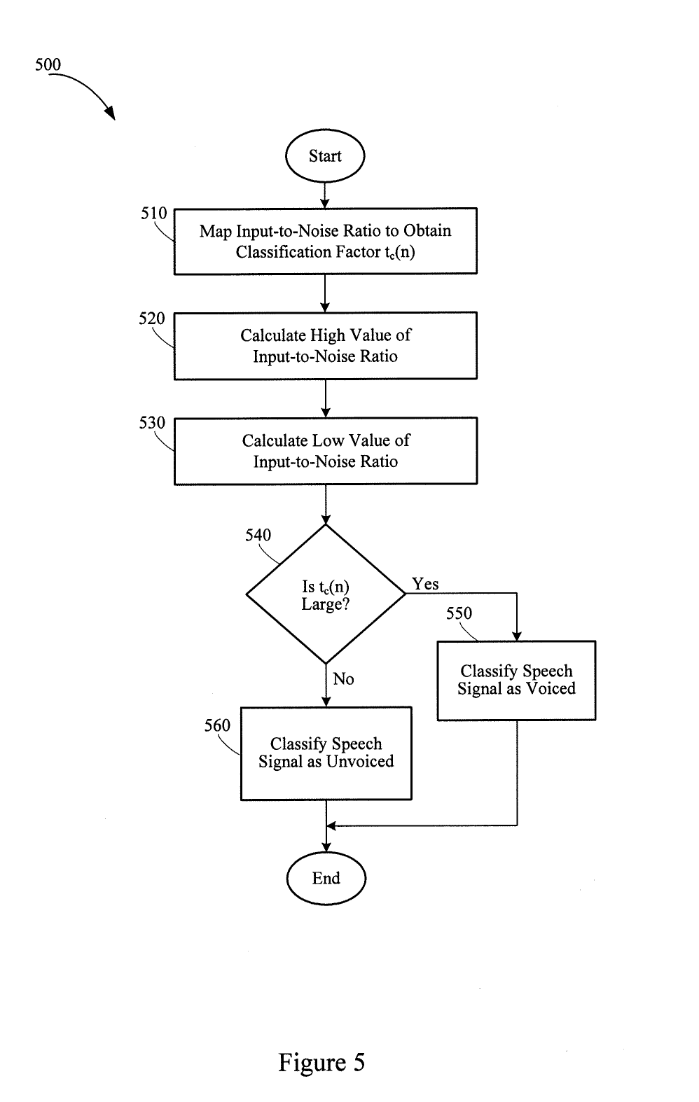

FIG. 5 is a classification process (Act 500). The input-to-noise ratio may be mapped to obtain the classification parameter (Act 510). A high value of the input-to-noise ratio may be calculated (Act 520), followed by calculation of a low value of the input-to-noise ratio (Act 530). The classification parameter may then be inspected to determine if it is large (Act 540). If the classification parameter is large, or greater than a predetermined value, the input speech signal may be classified as voiced (Act 550). If the classification parameter is small, or less than a predetermined value, the input speech signal may be classified as unvoiced (Act 560).

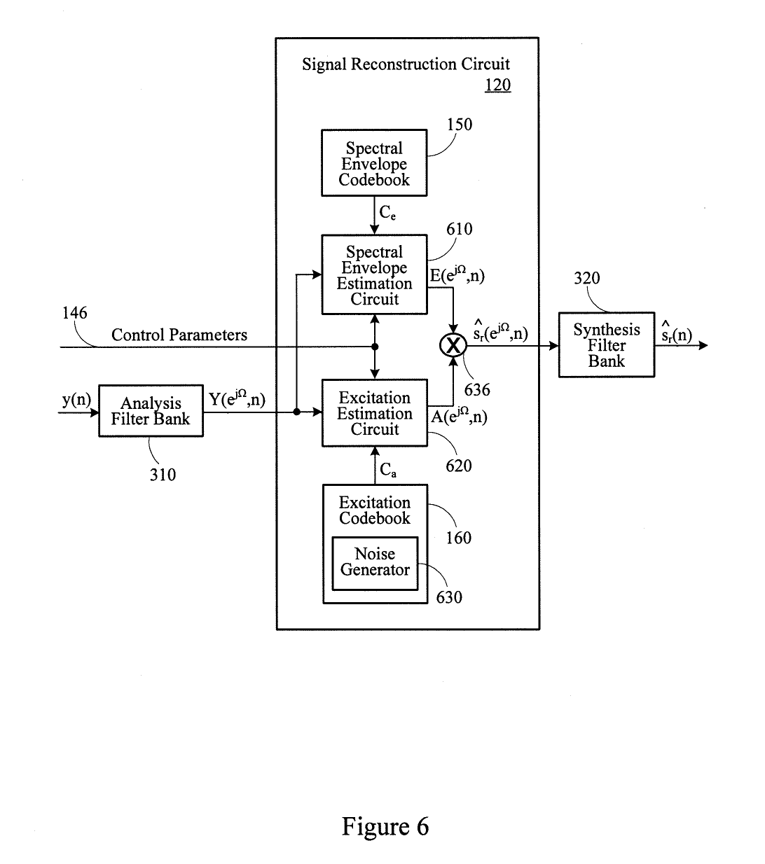

FIG. 6 is the signal reconstruction circuit 120. The analysis filter bank 310 may generate the sub-band signals Y(e^{jΩ}^{_{μ}}, n). A spectral envelope estimation circuit 610 may receive the sub-band signals Y(e^{jΩ}^{_{μ}}, n) and the operating parameters 146 from the control circuit 130. The spectral envelope estimation circuit 610 may also receive signals from the spectral envelope codebook 150, and may generate a spectral envelope E(e^{jΩ}^{_{μ}}, n) corresponding to an unperturbed speech signal, that is, a speech signal without noise contribution.

An excitation estimation circuit 620 may receive the sub-band signals Y(e^{jΩ}^{_{μ}}, n) and the operating parameters 146 from the control circuit 130. The excitation estimation circuit 620 may also receive signals from the excitation codebook 160, and may generate an excitation signal spectrum A(e^{jΩ}^{_{μ}}, n) corresponding to the unperturbed speech signal.

A multiplier circuit 636 may combine the spectral envelope E(e^{jΩ}^{_{μ}}, n) and the excitation signal spectrum A(e^{jΩ}^{_{μ}}, n) and generate a spectrum corresponding to a reconstructed speech signal based on Equation 9:

Ŝᵣ(e^{jΩ}^{_{μ}}, n)=A(e^{jΩ}^{_{μ}}, n) E(e^{jΩ}^{_{μ}}, n) (Eqn. 9)

The reconstruction synthesis filter bank 320 may synthesize the complete reconstructed speech signal ŝᵣ(n) based on the individual filter bands Ŝᵣ(e^{jΩ}^{_{μ}}, n). In some devices or processes, the reconstructed speech spectrum Ŝᵣ(e^{jΩ}^{_{μ}}, n) may be combined with a corresponding spectrum Ŝ_{g}(e^{jΩ}^{_{μ}}, n) generated by the noise reduction circuit 110.

The spectral envelope estimation circuit 610 may estimate a spectral envelope of the unperturbed speech signal by extracting a spectral envelope E_{S}(e^{jΩ}^{_{μ}}, n) of the speech input signal “y(n)”. The short-time spectral envelope may correspond to a speech parameter, such as “tone color.” The spectral envelope estimation circuit 610 may use a robust Linear Prediction Coding (LPC) process or a spectral analysis process to calculate coefficients of a predictive error filter. The coefficients of a predictive error filter may be used to determine parameters of the spectral envelope. In some devices, models of the spectral envelope representation may be based on line spectral frequencies, cepstral coefficients or melfrequency cepstral coefficients.

For example, the spectral envelope may be estimated by a double IIR smoothing process based on Equations 10 and 11:

$$\begin{matrix}{E}_{S} ( {e}^{{jΩ}_{μ}} , n ) = \{ \begin{matrix}{\tilde{E}}_{S} ( {e}^{{jΩ}_{μ}} , n ) , & if μ = M - 1 \\ \begin{matrix}{λ}_{E} {E}_{S} ( {e}^{{jΩ}_{μ + 1}} , n ) + \\ ( 1 - {λ}_{E} ) {\tilde{E}}_{S} ( {e}^{{jΩ}_{μ}} , n ) ,\end{matrix} & if μ ∈ \{ 0 , … , M - 2 \}\end{matrix} & ( Eqn . 10 ) \\ {\tilde{E}}_{S} ( {e}^{{jΩ}_{μ}} , n ) = \{ \begin{matrix}\vert Y ( {e}^{{jΩ}_{μ}} , n ) \vert , & if μ = 0 \\ \begin{matrix}{λ}_{E} {\tilde{E}}_{S} ( {e}^{{jΩ}_{μ - 1}} , n ) + \\ ( 1 - {λ}_{E} ) \vert Y ( {e}^{{jΩ}_{μ}} , n ) \vert ,\end{matrix} & if μ ∈ \{ 1 , … , M - 1 \}\end{matrix} & ( Eqn . 11 )\end{matrix}$$

where a smoothing constant λ_{E} may be selected as 0≦λ_{E}<1. For example, the smoothing constant λ_{E} may be about 0.5.

The extracted spectral envelope may represent an approximation of the spectral envelope of the unperturbed speech signal for signal portions that may not be significantly degraded by noise. To increase the accuracy of the spectral envelope for input signal portions having a low input-to-noise ratio or low signal-to-noise ratio, the spectral envelope codebook 150 may provide signals to the spectral envelope estimation circuit 610. The spectral envelope codebook 150 may be “trained,” and may include logarithmic representations of prototype spectral envelopes corresponding to particular sounds E_{CB,log}(e^{jΩ}^{_{μ}},0) to E_{CB,log}(e^{jΩ}^{_{μ}},N_{CB,e}−1). The spectral envelope codebook 150 may have a size N_{CB,e} of about 256. The spectral envelope codebook 150 may be a database containing the entries of the trained spectral envelopes.

For input signal portions having a high input-to-noise ratio, the spectral envelope estimation circuit 610 may search the spectral envelope codebook 150 for an entry that best matches the extracted spectral envelope E_{S}(e^{jΩ}^{_{μ}}, n). A normalized logarithmic version of the extracted spectral envelope may be calculated based on Equations 12 and 13:

\tilde{E}_{S,log}(e^{jΩ}^{_{μ}}, n)=20 log₁₀ E_{S}(e^{jΩ}^{_{μ}}, n)−E_{S,log,norm}(n) (Eqn. 12)

$${E}_{S , log , norm} ( n ) = \frac{{\sum }_{μ = 0}^{M - 1} M ( {Ω}_{μ} , n ) 20 {log}_{10} {E}_{S} ( {e}^{{jΩ}_{μ}} , n )}{{\sum }_{μ = 0}^{M - 1} M ( {Ω}_{μ} , n )} \qquad ( Eqn . 13 )$$

where a mask function M(Ω_{μ},n) may depend on the input-to-noise ratio based on Equation 14:

M(Ω_{μ},n)=g(input-to-noise ratio(Ω_{μ},n)) (Eqn. 14)

The mapping function “g” may map the values of the input-to-noise ratio to the interval [0, 1]. Resulting values close to about 1 may indicate a low noise level, meaning a low signal-to-noise ratio or a low input-to-noise ratio. The binary function g that may map to a value of about 1 may be selected if the input-to-noise ratio is greater than a predetermined threshold. The predetermined threshold may be between about 2 and about 4. A binary function g that maps to a small but finite real value may be selected if the input-to-noise ratio is less than or equal to the predetermined threshold, which may avoid division by zero.

Matching the spectral envelope of the spectral envelope codebook 150 and the spectral envelope extracted from the speech input signal may be performed using a mask function M(Ω_{μ},n) in the sub-band regime based on Equation 15:

M(Ω_{μ},n) E_{S}(e^{jΩ}^{_{μ}}, n)+(1−M(Ω_{μ},n)) E_{CB}(e^{jΩ}^{_{μ}}, n) (Eqn. 15)

where E_{S}(e^{jΩ}^{_{μ}}, n) and E_{CB}(e^{jΩ}^{_{μ}}, n) may be the smoothed extracted spectral envelope and the best matching spectral envelope of the spectral envelope codebook 150, respectively.

The mask function may depend on the input-to-noise ratio. For example, the mask function M(Ω_{μ},n) may be set to 1 if the input-to-noise ratio exceeds a predetermined threshold. The mask function M(Ω_{μ},n) may be set equal to ε if the input- to-noise ratio is below the predetermined threshold, where “ε” is a small positive real number.

The excitation signal may be filtered such that the reconstructed speech signal ŝᵣ(n) may be generated during signal portions for which speech is detected, and separately during signal portions for which speech is not detected. The excitation signal may be based on excitation sub-band signals Ã(e^{jΩ}^{_{μ}},n) and filtered excitation sub-band signals A(e^{jΩ}^{_{μ}},n). The filtered excitation sub-band signals A(e^{jΩ}^{_{μ}},n) may be generated using a spread noise reducing process Gₛ(e^{jΩ}^{_{μ}},n), which may be applied to the unfiltered excitation sub-band signals Ã(e^{jΩ}^{_{μ}},n) according to Equation 16:

A(e^{jΩ}^{_{μ}},n)=Gₛ(e^{jΩ}^{_{μ}},n) Ã(e^{jΩ}^{_{μ}},n) (Eqn. 16)

A spread noise reducing process may be used for signal reconstruction in a frequency range having a low input-to-noise ratio or low signal-to-noise ratio, with filter coefficients based on Equation 17:

Gₛ(e^{jΩ}^{_{μ}},n)=max {G(e^{jΩ}^{_{μ}},n), P₀(e^{jΩ}^{_{μ}},n), P₁(e^{jΩ}^{_{μ}},n, . . . , P_{M-1}(e^{jΩ}^{_{μ}},n)} (Eqn. 17)

where P_{ν}(e^{jΩ}^{_{μ}},n)=G(e^{jΩ}^{_{ν}},n)P(e^{jΩ}^{_{μ−ν}},n) for μ∈{0, . . . ,M−1}.

The term G(e^{jΩ}^{_{μ}},n) may denote the damping factors, and P(e^{jΩ}^{ₘ},n) may denote a spreading function. A modified Wiener filter may be used with characteristics based on Equation 18:

$$G ( {e}^{{jΩ}_{μ}} , n ) = max \{ \begin{matrix}{G}_{min} ( {e}^{{jΩ}_{μ}} , n ) , \\ 1 - β ( {e}^{{jΩ}_{μ}} , n ) \frac{{\hat{S}}_{nn} ( {Ω}_{n} , n )}{{\vert Y ( {e}^{{jΩ}_{μ}} , n ) \vert}^{2}}\end{matrix} \} \qquad ( Eqn . 18 )$$

The noise reduction circuit 110 may use the filter characteristics of Equation 18. When determining filtered excitation sub-band signals, a large overestimation factor β(e^{jΩ}^{_{μ}},n) and a high maximum damping, Gₘᵢₙ(e^{jΩ}^{_{μ}},n), may be selected for the spread filter. The value may be selected from the set of about [0.01, 0.1]. For signals having a relatively high input-to-noise ratio or signal-to-noise ratio, the signal reconstruction circuit 120 may adapt the phases of the sub-band signals of the reconstructed speech signal to the phases of the sub-band signals of the noise reduced signal.

The spectral envelopes of the spectral envelope codebook 150 may be normalized. The spectral envelope codebook 150 may be searched for a best matching entry based on a logarithmic input-to-noise ratio weighted magnitude distance according to Equations 19-21:

$${m}_{opt} ( n ) = {arg min}_{m} {\sum }_{μ = 0}^{M - 1} M ( {Ω}_{μ} , n ) \vert \begin{matrix}{\tilde{E}}_{S , log} ( {e}^{{jΩ}_{μ}} , n ) - \\ {\tilde{E}}_{CB , log} ( {e}^{{jΩ}_{μ}} , n , m )\end{matrix} \vert \qquad ( Eqn . 19 )$$

\tilde{E}_{CB,log}(e^{jΩ}^{_{μ}},n,m)=E_{CB,log}(e^{jΩ}^{_{ν}},m)−E_{CB,log,norm}(n,m) (m=0, . . . , N_{cb,e}) (Eqn. 20)

$${E}_{CB , log , norm} ( n , m ) = \frac{{\sum }_{μ = 0}^{M - 1} M ( {Ω}_{μ} , n ) {E}_{CB , log} ( {e}^{{jΩ}_{μ}} , m )}{{\sum }_{μ = 0}^{M - 1} M ( {Ω}_{μ} , n )} . \qquad ( Eqn . 21 )$$

The operator “arg min” in Equation 19 may represent the argument of a minimum function that returns a value for “m” for which the below quantity may assume a minimum value:

$${\sum }_{μ = 0}^{M - 1} M ( {Ω}_{μ} , n ) \vert {\tilde{E}}_{S , log} ( {e}^{{jΩ}_{μ}} , n ) - {\tilde{E}}_{CB , log} ( {e}^{{jΩ}_{μ}} , n , m ) \vert$$

The spectral envelope obtained from the spectral envelope codebook 150 may be linearized and normalized based on Equation 22:

EC(EB (ja ,n) =1 ₀(ECB.I(e ,n,mpt(n))+Es,,,,g,₀(n))/20 (Eqn. 22)

For the portion of the speech input signal having a low input-to-noise ratio or low signal-to-noise ratio, the spectral envelope E_{CB}(e^{jΩ}^{_{μ}}, n) obtained from the spectral envelope codebook 150 may be used based on Equations 23-25. For the portion of the speech input signal having a high input-to-noise ratio or high signal-to-noise ratio, the extracted spectral envelope E_{S}(e^{jΩ}^{_{μ}}, n) may be used based on Equations 23-25. Equations 23-25 may represent a specific spectral envelope determined by the spectral envelope estimation circuit 610:

$$\begin{matrix}E ( {e}^{{jΩ}_{μ}} , n ) = \{ \begin{matrix}\tilde{E} ( {e}^{{jΩ}_{μ}} , n ) , & if μ = M - 1 \\ \begin{matrix}{λ}_{mix} E ( {e}^{{jΩ}_{μ + 1}} , n ) + \\ ( 1 - {λ}_{mix} ) \tilde{E} ( {e}^{{jΩ}_{μ}} , n ) ,\end{matrix} & if μ ∈ \{ 0 , … , M - 2 \}\end{matrix} & ( Eqn . 23 ) \\ \tilde{E} ( {e}^{{jΩ}_{μ}} , n ) = \{ \begin{matrix}\breve{E} ( {e}^{{jΩ}_{μ}} , n ) , & if μ = 0 \\ \begin{matrix}{λ}_{mix} \tilde{E} ( {e}^{{jΩ}_{μ - 1}} , n ) + \\ ( 1 - {λ}_{mix} ) \breve{E} ( {e}^{{jΩ}_{μ}} , n ) ,\end{matrix} & if μ ∈ \{ 1 , … , M - 1 \}\end{matrix} & ( Eqn . 24 ) \\ \breve{E} ( {e}^{{jΩ}_{μ}} , n ) = M ( {Ω}_{μ} , n ) {E}_{S} ( {e}^{{jΩ}_{μ}} , n ) + ( 1 - M ( {Ω}_{μ} , n ) ) {E}_{CB} ( {e}^{{jΩ}_{μ}} , n ) . & ( Eqn . 25 )\end{matrix}$$

where the smoothing constant, λₘᵢₓ, may be about 0.3, and may range from about 0 to about 1.

The excitation estimation circuit 620 may receive signals from the excitation codebook 160 and estimate an excitation signal. The excitation signal may be shaped with the spectral envelope E(e^{jΩ}^{_{μ}}, n) provided by the spectral envelope estimation circuit 610 to obtain the reconstructed speech signal.

If the speech input signal is noisy, the excitation codebook 160 entry may be used because the extracted spectral envelope may not sufficiently resemble the spectral envelope of the unperturbed speech signal. If the speech input signal is noisy, a voice pitch of a voiced signal portion may be estimated, and an excitation codebook entry may be determined before the excitation signal is generated.

The excitation codebook 160 may include entries representing weighted sums of sinus or sinusoidal oscillations. The excitation codebook entries may be represented by a matrix C_{g} of weighted sums of sinus oscillations, where the entries in a row “k+1” may include the oscillations of a row “k”, and may further include a single additional oscillation. The excitation codebook 160 may be a database containing the entries.

The excitation signal a(n) may be based on voiced and unvoiced signal portions. Unvoiced portions ãᵤ,(n) of the excitation signal ã (n) may be generated by a noise generator 630. The voiced portion ãᵥ(n) of the excitation signal ã (n) may be based on voice pitch. Determining the voice pitch may described in an article entitled “Pitch Determination of Speech Signals,” by W. Hess, Springer Berlin, 1983, which is incorporated by reference. The excitation signal ã (n) may be calculated as a weighted summation of the voiced portion ãᵥ(n) and the unvoiced portion ãᵤ(n). An excitation signal ã (n) may be based on Equation 26:

ã(n)=t_{c}(round(n/r))ãᵥ(n)+[1−t_{c} (round(n/r))]ãᵤ(n) (Eqn. 26)

Based on the determined pitch a voiced portion ãᵥ(n) and the excitation signal ã (n) may be generated using the excitation codebook 160 with entries that may represent a weighted sums of sinus oscillations based on Equation 27:

$${c}_{s , k} ( l ) = {\sum }_{m = 0}^{k} {0.99}^{m} sin ( \frac{2 π l ( m + 1 )}{L} ) \qquad ( Eqn . 27 )$$

where L may denote a length of each codebook entry.

The entries c_{s,k}(1) may be coefficients of a matrix Cₐ used to generate the voiced portion ãᵥ(n) of an excitation signal based on Equation 28:

ã(n) as ãᵥ(n)=c_{s,I}_{_{z}}₍ₙ₎(Iₛ(n)) (Eqn. 28)

where 1_{z}(n) may denote an index of the row, and 1ₛ(n) may denote an index of the column of the matrix Cₐ formed by the coefficients c_{s,k}(1).

An index of the row may be calculated based on Equation 29:

$${l}_{z} ( n ) = round ( \frac{{T}_{0} ( round ( n / r ) )}{2} - 1 ) \qquad ( Eqn . 29 )$$

where “τ₀” may be a period of the voice pitch (which may be time dependent) and r/n may represent a down-sampled calculation of the period of the pitch. The pitch may be calculated every “r” sampling instants.

An index of the column may be calculated based on Equations 30-31:

1ₛ(n)=round(Ĩₛ(n)) (Eqn. 30)

$${\tilde{l}}_{s} ( n ) = \{ \begin{matrix}{\tilde{l}}_{s} ( n - 1 ) + {Δ}_{s} ( n ) , & if {\tilde{l}}_{s} ( n - 1 ) + {Δ}_{s} ( n ) < L - 1.5 \\ {\tilde{l}}_{s} ( n - 1 ) + {Δ}_{s} ( n ) - L , & else\end{matrix} \qquad ( Eqn . 31 )$$

where the increment Δₛ(n)=L/(τ₀(round(n/r))). The subtraction by the value of 1.5 in Equation 31 may ensure that the index of the column satisfies the relation 0≦Iₛ(n)≦L−1.

The signal combining circuit 140 may combine the reconstructed speech signal ŝᵣ(n) and the noise reduced signal ŝ_{g}(n) based on a weighted sum. The weights may be based on the estimated input-to-noise ratio or signal-to-noise ratio. If the reconstructed speech signal ŝᵣ(n) and the noise reduced signal ŝ_{g}(n) are processed as sub-band signals, the weights may vary with the discrete frequency nodes Ω_{μ} determined by the analysis filter bank. In a frequency range or sub-band having an input-to-noise ratio below a predetermined threshold, the weights may be selected so that the contribution of the reconstructed speech signal ŝᵣ(n) to the speech output signal dominates the contribution of the noise reduced signal ŝ_{g}(n).

Modified sub-band signals Ŝ_{r,mod}(e^{jΩ}^{_{μ}},n) and the noise reduced sub-band signals Ŝ_{g}(e^{jΩ}^{_{μ}},n) may be represented as a weighted summation based on Equation 32:

Ŝ(e^{jΩ}^{_{μ}},n)=H_{g}(e^{jΩ}^{_{μ}},n)Ŝ_{g}(e^{jΩ}^{_{μ}},n)+Hᵣ(e^{jΩ}^{_{μ}},n)Ŝ_{r,mod}(e^{jΩ}^{_{μ}},n) (Eqn. 32)

where the weight values H_{g}(e^{jΩ}^{_{μ}},n) and Hᵣ(e^{jΩ}^{_{μ}},n) may depend on the input-to-noise ratio. The weights may be determined by mean values of the input-to-noise ratio obtained using ρ Mel filters, where ρ∈{0, 1, . . . , Mₘₑₗ−1}, having frequency responses F_{ρ}(e^{jΩ}^{_{μ}}). For a sampling rate of 11025 Hz, the value of Mₘₑₗ may be about 16. The average input-to-noise ratio may be based on Equation 33:

$$input \text{-} to \text{-} noise {ratio}_{av} ( ρ , n ) = \frac{{\sum }_{μ = 0}^{M - 1} {F}_{ρ} ( {e}^{{jΩ}_{μ}} ) INR ( {Ω}_{μ} , n )}{{\sum }_{μ = 0}^{M - 1} {F}_{ρ} ( {e}^{{jΩ}_{μ}} )} \qquad ( Eqn . 33 )$$

The weights H_{g}(e^{jΩ}^{_{μ}},n) and Hᵣ(e^{jΩ}^{_{μ}},n) may be determined based the input-to-noise ratioₐᵥ (ρ, n) using binary characteristics according to Equation 34:

fₘᵢₓ(input-to-noise ratioₐᵥ (ρ, n))=1 (Eqn. 34)

where the input-to-noise ratioₐᵥ (ρ, n) >a threshold value that may be selected from the interval [4, 10], and where fₘᵢₓ(input-to-noise ratioₐᵥ (ρ, n))=0. Other non-binary characteristics may be used.

Based on Equations 32-34, the weights for the combination of the modified sub-band signal Ŝ_{r,mod}(e^{jΩ}^{_{μ}},n) and the noise reduced sub-band signal Ŝ_{g}(e^{jΩ}^{_{μ}},n) may be calculated according to Equation 35:

$${H}_{g} ( {e}^{{jΩ}_{μ}} , n ) = {\sum }_{ρ = 0}^{{M}_{met}} {f}_{mix} ( input \text{-} to \text{-} noise {ratio}_{av} ( ρ , n ) ) {F}_{ρ} ( {e}^{{jΩ}_{μ}} ) \qquad ( Eqn . 35 )$$

where Hᵣ(e^{jΩ}^{_{ν}},n)=1−H_{g}(e^{jΩ}^{_{μ}},n).

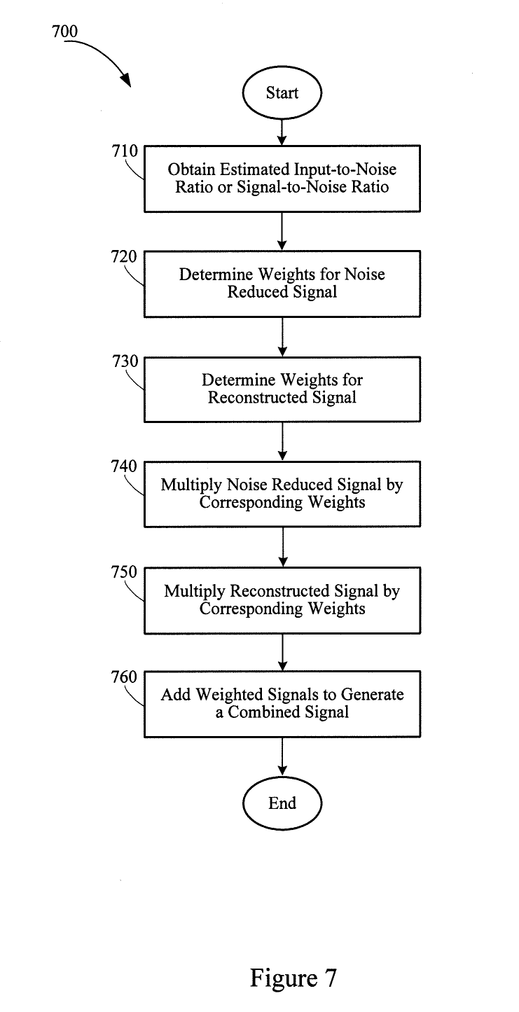

FIG. 7 is a weighting process (Act 700). The estimated input-to-noise ratio or signal-to-noise ratio may be obtained (Act 710). Weighting values may be assigned to the noise-reduced signal (Act 720) and the reconstructed signal (Act 730), respectively. The noise-reduced signal may then be multiplied by the corresponding weighting values (Act 740), and the reconstructed signal may then be multiplied by the corresponding weighting values (Act 750). The combining circuit may perform a sum of products operation by adding the weighted noise-reduced signal and the weighted reconstructed signal to generate the combined signal (Act 760).

Before combining the sub-band signals Ŝᵣ(^{jΩ}^{_{μ}},n) and Ŝ_{g}(e^{jΩ}^{_{μ}},n), the phase of the reconstructed speech signal may be adapted to the phase of the noise reduced signal ŝ_{g}(n) according to Equation 36:

$${\hat{S}}_{r , mod} ( {e}^{{jΩ}_{μ}} , n ) = \{ \begin{matrix}\vert \frac{{\hat{S}}_{r} ( {e}^{{jΩ}_{μ}} , n )}{{\hat{S}}_{g} ( {e}^{{jΩ}_{μ}} , n )} \vert {\hat{S}}_{g} ( {e}^{{jΩ}_{μ}} , n ) , & if INR ( {Ω}_{μ} , n ) > some threshold \\ {\hat{S}}_{r} ( {e}^{{jΩ}_{μ}} , n ) , & else .\end{matrix} \qquad ( Eqn . 36 )$$

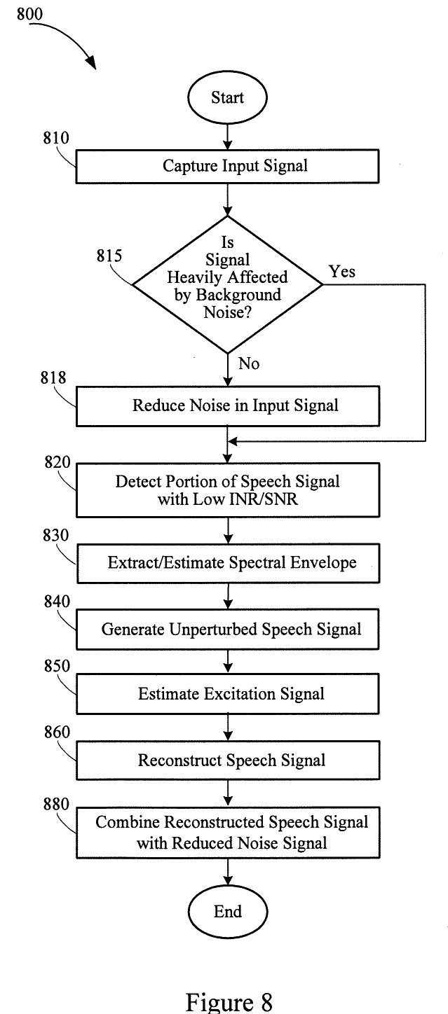

FIG. 8 is a signal enhancement process (Act 800). One or more devices that convert sound into operating signals (e.g., a microphone), may capture an input signal (Act 810). If the level of background noise in the input signal is less than a predetermined maximum value (Act 815), that is, it is not heavily affected by the background noise, a noise reduction circuit or filter may reduce the level of background noise in the input signal (Act 818). If the input signal is affected by background noise, a portion of the input signal having a signal-to-noise ratio (signal-to-noise ratio) below a predetermined threshold may be detected (Act 820). Because the signal-to-noise ratio may be lower than the predetermined threshold, the signal may be degraded by the background noise.

A spectral envelope of the speech signal may be extracted and estimated from the input signal (Act 830). The extracted speech signal may be estimated to generate an unperturbed speech signal (Act 840). Next, an excitation signal may be estimated based on a classification of voiced and unvoiced portions of speech in the input signal (Act 850). A reconstructed speech signal may be generated based on the estimated spectral envelope and the estimated excitation signal (Act 860). The noise-reduced signal and the reconstructed speech signal may be combined (Act 880) based on a weighted summation. The weighting values may depend on the signal-to-noise ratio of the input signal.

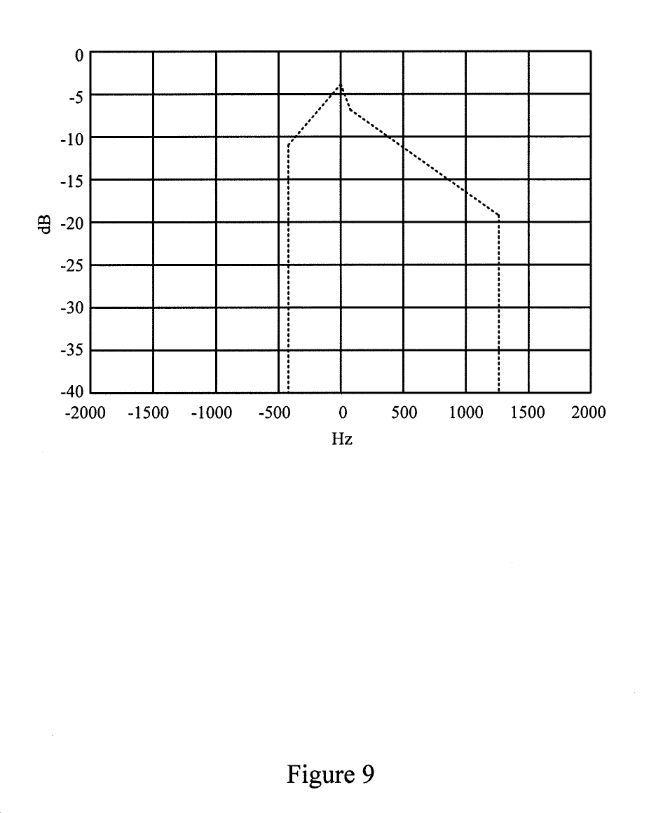

FIG. 9 is a frequency response of a real-value positive spreading function. The spreading function may correspond to Equations 17 and 18. The term P(e^{jΩ}^{ₘ},n) in Equation 17 may denote the spreading function.

The logic, circuitry, and processing described above may be encoded in a computer-readable medium such as a CDROM, disk, flash memory, RAM or ROM, an electromagnetic signal, or other machine-readable medium as instructions for execution by a processor. Alternatively or additionally, the logic may be implemented as analog or digital logic using hardware, such as one or more integrated circuits (including amplifiers, adders, delays, and filters), or one or more processors executing amplification, adding, delaying, and filtering instructions; or in software in an application programming interface (API) or in a Dynamic Link Library (DLL), functions available in a shared memory or defined as local or remote procedure calls; or as a combination of hardware and software.

The logic may be represented in (e.g., stored on or in) a computer-readable medium, machine-readable medium, propagated-signal medium, and/or signal-bearing medium. The media may comprise any device that contains, stores, communicates, propagates, or transports executable instructions for use by or in connection with an instruction executable system, apparatus, or device. The machine-readable medium may selectively be, but is not limited to, an electronic, magnetic, optical, electromagnetic, or infrared signal or a semiconductor system, apparatus, device, or propagation medium. A non-exhaustive list of examples of a machine-readable medium includes: a magnetic or optical disk, a volatile memory such as a Random Access Memory “RAM,” a Read-Only Memory “ROM,” an Erasable Programmable Read-Only Memory (i.e., EPROM) or Flash memory, or an optical fiber. A machine-readable medium may also include a tangible medium upon which executable instructions are printed, as the logic may be electronically stored as an image or in another format (e.g., through an optical scan), then compiled, and/or interpreted or otherwise processed. The processed medium may then be stored in a computer and/or machine memory.

The systems may include additional or different logic and may be implemented in many different ways. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several memories and processors. The systems may be included in a wide variety of electronic devices, including a cellular phone, a headset, a hands-free set, a speakerphone, communication interface, or an infotainment system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for processing a speech input signal, comprising:
estimating an input-signal-to-noise ratio or a signal-to-noise ratio of the speech input signal;
generating an excitation signal corresponding to the speech input signal;
extracting a spectral envelope of the speech input signal;
generating a reconstructed speech signal based on the excitation signal and the extracted spectral envelope;
filtering the speech input signal with a noise reduction circuit to generate a noise reduced signal; and
combining the reconstructed speech signal and the noise reduced signal based on the input-signal-to-noise ratio or the signal-to-noise ratio to generate an enhanced speech output signal.

2. The method according to claim 1, further comprising:
calculating a weight corresponding to the reconstructed speech signal based on the input-signal-to-noise ratio or the signal-to-noise ratio to generate a weighted reconstructed speech signal;
calculating a weight corresponding to the noise reduced signal based on the input-signal-to-noise ratio or the signal-to-noise ratio to obtain a weighted noise reduced signal; and where
generating the enhanced speech output signal comprises combining the weighted reconstructed speech signal and the weighted noise reduced signal.

3. The method according to claim 1 where estimating the input-signal-to-noise ratio or the signal-to-noise ratio further comprises:
estimating the short-time power density spectrum of noise corresponding to the speech input signal; and
determining a short-time spectrogram of the speech input signal.

4. The method according to claim 3, where estimating the short-time power density spectrum of the noise further comprises:
smoothing the short-time power density spectrum of the speech input signal in time to generate a first smoothed short-time power density spectrum;
smoothing the first smoothed short-time power density spectrum in a positive frequency direction to generate a second smoothed short-time power density spectrum;
smoothing the second smoothed short-time power density spectrum in a negative frequency direction to obtain a third smoothed short-time power density spectrum; and
determining a minimum of the third smoothed short-time power density spectrum for a discrete time index n and the estimated short-time power density spectrum of the noise for a discrete time index n−1.

5. The method according to claim 1, where the excitation signal is generated using an excitation codebook.

6. The method according to claim 1, where the reconstructed speech signal is based on an estimated spectral envelope derived from the extracted spectral envelope and a spectral envelope codebook.

7. The method according to claim 6, further comprising:
generating a prototype spectral envelope corresponding to the spectral envelope codebook, the prototype spectral envelope providing a best match to the extracted spectral envelope corresponding to portions of the speech input signal having an input-signal-to-noise ratio greater than a predetermined threshold; and
where the estimated spectral envelope further comprises:
the prototype spectral envelope best match; and
the extracted spectral envelope corresponding to portions of the speech input signal having an input-signal-to-noise ratio less than or equal to the predetermined threshold.

8. The method according to claim 7, further comprising generating the estimated spectral envelope as sub-bands based on a weighted sum of the extracted spectral envelope smoothed in frequency and the prototype spectral envelope best match.

9. The method according to claim 8, further comprising generating the excitation signal based on filtered excitation sub-band signals, where the filtered excitation sub-band signals are generated using a spread noise reduction filter.

10. The method according to claim 1, further comprising:
generating sub-band signals corresponding to the reconstructed speech signal;
generating sub-band signals corresponding to the noise reduced signal;
adapting phases of the sub-band signals corresponding to the reconstructed speech signal to phases of the sub-band signals corresponding to the noise reduced signal; and
where adapting the phases is based on the input-signal-to-noise ratio of the speech input signal.

11. A computer-readable storage medium having processor executable instructions to process a speech input signal by performing the acts of:
estimating an input-signal-to-noise ratio or a signal-to-noise ratio of the speech input signal;
generating an excitation signal corresponding to the speech input signal;
extracting a spectral envelope of the speech input signal;
generating a reconstructed speech signal based on the excitation signal and the extracted spectral envelope;
filtering the speech input signal with a noise reduction circuit to generate a noise reduced signal; and
combining the reconstructed speech signal and the noise reduced signal based on the input-signal-to-noise ratio or the signal-to-noise ratio to generate an enhanced speech output signal.

12. The computer-readable storage medium of claim 11, further comprising processor executable instructions to cause a processor to perform the acts of:
calculating a weight corresponding to the reconstructed speech signal based on the input-signal-to-noise ratio or the signal-to-noise ratio to generate a weighted reconstructed speech signal;
calculating a weight corresponding to the noise reduced signal based on the input-signal-to-noise ratio or the signal-to-noise ratio to obtain a weighted noise reduced signal; and where
generating the enhanced speech output signal comprises combining the weighted reconstructed speech signal and the weighted noise reduced signal.

13. The computer-readable storage medium of claim 11, further comprising processor executable instructions to cause a processor to perform the acts of estimating the input-signal-to-noise ratio or the signal-to-noise ratio by:
estimating the short-time power density spectrum of noise corresponding to the speech input signal; and
determining a short-time spectrogram of the speech input signal.

14. The computer-readable storage medium of claim 13, further comprising processor executable instructions to cause a processor to perform the acts of estimating the short-time power density spectrum of the noise by
smoothing the short-time power density spectrum of the speech input signal in time to generate a first smoothed short-time power density spectrum;
smoothing the first smoothed short-time power density spectrum in a positive frequency direction to generate a second smoothed short-time power density spectrum;
smoothing the second smoothed short-time power density spectrum in a negative frequency direction to obtain a third smoothed short-time power density spectrum; and
determining a minimum of the third smoothed short-time power density spectrum for a discrete time index n and the estimated short-time power density spectrum of the noise for a discrete time index n−1.

15. The computer-readable storage medium of claim 11, further comprising processor executable instructions to cause a processor to perform the act of accessing an excitation codebook to generate the excitation signal.

16. The computer-readable storage medium of claim 11, further comprising processor executable instructions to cause a processor to perform the acts of generating the reconstructed speech signal based on an estimated spectral envelope derived from the extracted spectral envelope and a spectral envelope codebook.

17. The computer-readable storage medium of claim 16, further comprising processor executable instructions to cause a processor to perform the acts of:
generating a prototype spectral envelope corresponding to the spectral envelope codebook, the prototype spectral envelope providing a best match to the extracted spectral envelope corresponding to portions of the speech input signal having an input-signal-to-noise ratio greater than a predetermined threshold; and
where the estimated spectral envelope further comprises:
the prototype spectral envelope best match; and
the extracted spectral envelope corresponding to portions of the speech input signal having an input-signal-to-noise ratio less than or equal to the predetermined threshold.

18. The computer-readable storage medium of claim 17, further comprising processor executable instructions to cause a processor to perform the acts of generating the estimated spectral envelope as sub-bands based on a weighted sum of the extracted spectral envelope smoothed in frequency and the prototype spectral envelope best match.

19. The computer-readable storage medium of claim 18, further comprising processor executable instructions to cause a processor to perform the acts of generating the excitation signal based on filtered excitation sub-band signals, where the filtered excitation sub-band signals are generated using a spread noise reduction filter.

20. The computer-readable storage medium of claim 11, further comprising processor executable instructions to cause a processor to perform the acts of:
generating sub-band signals corresponding to the reconstructed speech signal;
generating sub-band signals corresponding to the noise reduced signal;
adapting phases of the sub-band signals corresponding to the reconstructed speech signal to phases of the sub-band signals corresponding to the noise reduced signal; and
where adapting the phases is based on the input-signal-to-noise ratio of the speech input signal.

21. A signal processing system for enhancing a speech input signal, comprising:
a noise reduction circuit configured to receive the speech input signal and generate a noise reduced signal;
a signal reconstruction circuit configured to receive the speech input signal and extract a spectral envelope from the speech input signal, the signal reconstruction circuit further configured to
generate an excitation signal based on the speech input signal; and
generate a reconstructed speech signal based on the extracted spectral envelope and the excitation signal;
a signal combining circuit configured to combine the noise reduced signal and the reconstructed speech signal to generate an enhanced speech output signal; and
a control circuit configured to receive the speech input signal and control the signal reconstruction circuit and the signal combining circuit based on an input-signal-to-noise ratio or a signal-to-noise ratio of the speech input signal.

22. The system according to claim 21, further comprising:
at least one analysis filter bank configured to transform the speech input signal into speech input sub-band signals;
at least one synthesis filter bank configured to synthesize sub-band signals generated by the noise reduction circuit and/or the signal reconstruction circuit.

23. The system according to claim 22, where the signal reconstruction circuit further comprises:
an excitation codebook;
a spectral envelope codebook;
an excitation estimation circuit configured to generate the excitation signal based on the excitation codebook;
a spectral envelope estimation circuit configured to generate an estimated spectral envelope based on the spectral envelope codebook; and
where the signal reconstruction circuit generates the reconstructed speech signal based on the estimated spectral envelope and the excitation signal.

24. The system according to claim 21, where the control circuit determines the input-signal-to-noise ratio or the signal-to-noise ratio of the speech input signal, and deactivates the signal reconstruction circuit if the determined input-signal-to-noise ratio or the signal-to-noise ratio exceeds a predetermined threshold.
